(19) United States
(12) Patent Application Publication
(10) Pub. No.: US 2009/0196134 A1
(43) Pub. Date: Aug. 6, 2009

(54) REPRODUCTION UNIT AND REPRODUCTION METHOD IN REPRODUCTION UNIT

(75) Inventor: Mikio Yamamuro, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/349,048

(22) Filed: Jan. 6, 2009

(30) Foreign Application Priority Data
Jan. 31, 2008 (JP) 2008-021409

(51) Int. Cl. G11B 20/10

(52) U.S. Cl. 369/47.14

(57) ABSTRACT

According to one embodiment, a reproduction unit of a recording medium in which in a field where a pattern signal repeated by a fixed frequency is recorded, reproduction data is recorded so that an integral multiple of a minimum unit of a pattern thereof is a one-byte unit, the reproduction unit includes a detection section for defecting a minimum unit pattern from the pattern signal, a synchronization code determination section for determining a synchronization code following the pattern signal and predicting head timing of data following the synchronization code, a pattern forming section for forming an integral number of phase pattern signals from the minimum unit pattern detected by the detection section, and timing coincidence determination section for determining whether each of the integral number of phase pattern signals coincides with the head timing of the data predicted by the synchronization code determination section.

### CROSS-REFERENCE TO RELATED APPLICATIONS

This application is based upon and claims the benefit of priority from Japanese Patent Application No. 2003-021409, filed Jan. 31, 2008, the entire contents of which are incorporated herein by reference.

### BACKGROUND

1. Field

One embodiment of the present invention relates to a reproduction unit and to a reproduction, method in a reproduction unit. More particularly, it relates to an optical disc reproduction unit and to a reproduction method in an optical disc reproduction unit.

2. Description of the Related Art

Reproduction-only or recordable optical discs of a compact disc (CD) type, a digital versatile disc (DVD) type or a high definition digital versatile disc (HD DVD) type are used as recording media capable of storing digital images.

For example, a data segment of the HD DVD

type disc is composed of a variable frequency oscillator (VFO) field, a data field, a postamble field, a reserved field and a buffer field. The VFO field contains 7 Eh. A modulation pattern is a repetition of “010001000100”. A synchronization code (SYNC code) is allocated at the head of the data field following the VFO field, and data is allocated to follow the synchronization code.

For example, when reproduction data recorded in the above-mentioned HD DVD type disc is reproduced, a reproduction unit uses a reproduction clock to reproduce the repetitive pattern obtained from the VFO field and tune the frequency. Then, the reproduction unit reproduces the synchronization code, synchronizes the phase of the reproduction data, and detects head timing of data following the synchronization code. When the head timing is detected, the reproduction unit judges that a channel bit corresponding to the head timing is the head of the data, and demodulates the data.

There has heretofore been proposed a disc reproduction unit and a disc reproduction method, wherein when a synchronization code is to be detected, a detection window is fully opened to detect the synchronization code, and the head of the reproduction data is found (refer to Jpn. Pat. Appln. KOKAI Publication No. 2006-294183).

However, when the data is reproduced as described above, the synchronization code is reproduced to synchronize the phase of the data, and the head timing of the reproduction data is detected, so that if the reading of the synchronization code is unstable, the detection of the head timing of the data becomes difficult, which may preclude the reproduction of the data.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram schematically showing one configuration example of a reproduction unit according to one embodiment of the present invention;

FIG. 2 is an exemplary diagram for explaining one example of the layout of data recorded in a recording medium;

FIG. 3 is an exemplary block diagram schematically showing one configuration example of a reproduction timing detection section in the reproduction unit shown in FIG. 1;

FIG. 4 is an exemplary timing chart for explaining one example of a reproduction method according to one embodiment of the present invention;

FIG. 5 is an exemplary timing chart for explaining another example of the reproduction method according to one embodiment of the present invention; and

FIG. 6 is an exemplary flowchart for explaining one example of the reproduction method according to one embodiment of the present invention.

### DETAILED DESCRIPTION

Various embodiments according to the invention will be described hereinafter with reference to the drawings. In general, according to one embodiment of the invention, there is provided a reproduction unit of a recording medium in which in a field where a pattern signal repeated by a fixed frequency is recorded, reproduction data is recorded so that an integral multiple of a minimum unit of a pattern thereof is a one-byte unit, the reproduction unit comprising: detection means for detecting a minimum, unit pattern from the pattern signal; pattern forming means for forming an integral number of phase pattern signals from the minimum unit pattern detected by the detection means; synchronization code determination means for determining a synchronization code following the pattern signal and predicting head timing of data following the synchronization code; and coincidence determination means for determining whether each of the integral number of phase pattern signals coincides with the head timing of the data predicted by the synchronization code determination means.

A reproduction unit and a reproduction method according to a first embodiment of the present invention will be described below with reference to the drawings. It is to be noted that the reproduction unit according to the present embodiment is an optical disc apparatus for reproducing data recorded in an optical disc.

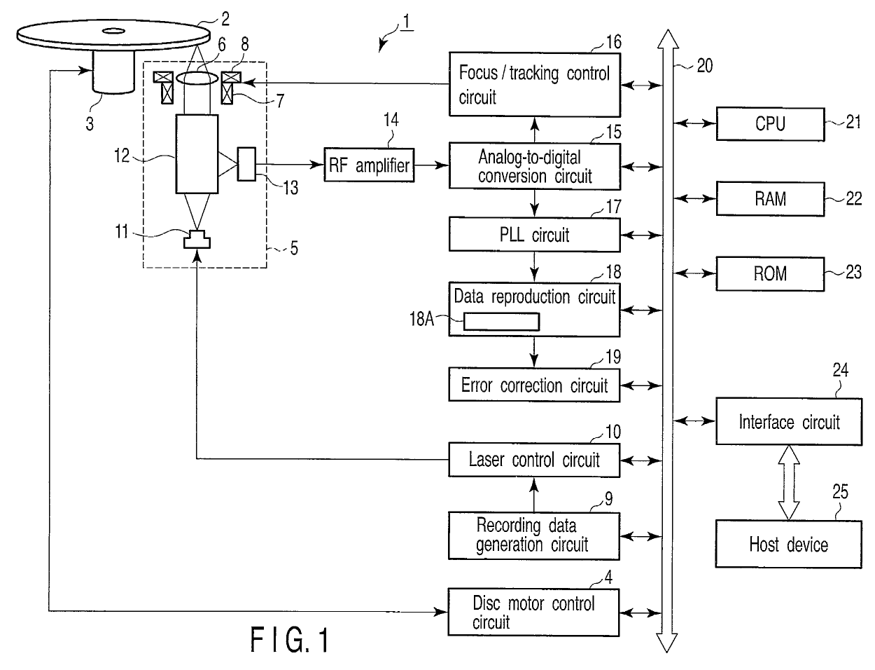

FIG. 1 is a block diagram showing the optical disc apparatus according to the first embodiment of the present invention. An optical disc 2 is a reproduction-only or recordable optical disc of a CD type, a DVD type or an HD DVD type.

For example, the DVD type includes reproduction-only DVD-Video and DVD-ROM (read only memory), and recordable DVD-R (recordable), DVD-RW (rewritable) or DVD-RAM (random access memory). As the optical disc 2, the reproduction unit according to the present embodiment uses an optical disc in which reproduction data is recorded so that an integral multiple of a minimum unit of a repeated pattern is a one-byte unit in a pattern field where the pattern is repeated by a fixed frequency.

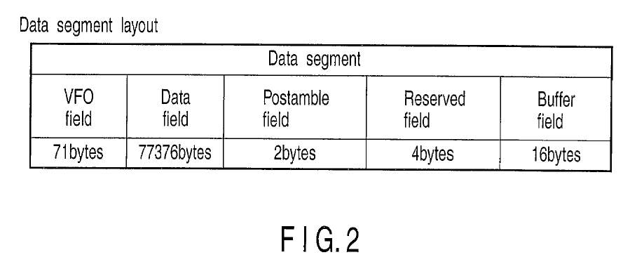

For example, when the optical disc 2 is an HD DVD type optical disc, the reproduction data is modulated by an 8-12 modulation method and recorded in the optical disc 2, and one byte is equal to 12 channel bits. As shown in FIG. 2, a data segment of the HD DVD type optical disc is composed of a variable frequency oscillator (VFO) field, a data field, a postamble field, a reserved field and a buffer field. The VFO field contains 7 Eh. A modulation pattern is a repetition of “010001000100”.

Among signals recorded in the optical disc 2, in the pattern field, for example, the VFO field where the pattern is repeated by a fixed frequency, a 4-channel-bit pattern “0100” which is a minimum unit pattern is repeated three times within a one-byte unit. That is, in this case, triple the minimum unit pattern “0100” is equal to the one-byte unit of the reproduction data recorded in the optical disc 2.

Furthermore, when the optical disc 2 is a DVD-RAM type disc, the reproduction data is modulated by an 8-16 modulation method and recorded in the optical disc 2, and one byte is equal to 16 channel bits. Among signals recorded in the optical disc 2, in the pattern field, for example, the VFO field where the pattern is repeated by a fixed frequency, a 4-channel-bit pattern “1000” which is a minimum unit pattern is repeated four times within a one-byte unit. That is, in this case, four times the minimum unit pattern “1000” is equal to the one-byte unit of the signal recorded in the optical disc 2.

The optical disc 2 is rotationally driven by a disc motor 3. The disc motor 3 is controlled by a disc motor control circuit 4. Information is recorded in or reproduced from the optical disc 2 by an optical pickup 5. The optical pickup 5 is provided with an objective lens 6. The objective lens 6 can be moved in a focusing direction (the optical axis direction of the lens) by the driving of a focusing actuator 7, and can also be moved in a tracking direction (a direction perpendicular to the optical axis of the lens, and the diametrical direction of the optical disc) by the driving of a tracking actuator 8.

A recording data generation circuit 9 adds an error correction code to data supplied from a host device 25 via an interface circuit 24 at the time of information recording, and attaches a synchronization code, etc., to the data to change it into a recording-format, and further modulates the data, and then provides the modulated data to a laser control circuit 10. At the time of information recording (mark formation), the laser control circuit 10 supplies a write signal to a laser diode 11 in the optical pickup 5 on the basis of the data supplied from the recording data generation circuit 9.

The laser diode 11 includes a laser diode 11a for a CD of a wavelength of 780 nanometers (nm), a laser diode 11b for a DVD of a wavelength of about 650 nm, and a laser diode 11c for an HD-DVD of a wavelength of about 405 nm. One of these laser diodes is suitably used depending on the kind of optical disc mounted on the optical disc apparatus, and selected in accordance with the signal supplied from the laser control circuit 10, and thus emits laser light.

The laser light generated from the laser diode 11 is applied onto the optical disc 2 via an optical section 12 and the objective lens 6. The laser light generated from the laser diode 11 and then reflected by the optical disc 2 is guided to a photodetector 13 via the objective lens 6 and the optical section 12. An output signal from the photodetector 13 is supplied to an RF amplifier 14.

The RF amplifier 14 processes a detection signal from the photodetector 13, and generates a focus error signal (FE signal) indicating an error with respect to a just-focused state, a tracking error signal (TE signal) indicating an error of the beam spot center of the laser light with respect to the center of a track, and a reproduction signal (RF signal). The RF amplifier 14 supplies the generated FE signal, TE signal and RF signal to an analog-to-digital converter 15.

When processing the detection signal from the photodetector 13, the RF amplifier 14 sets, to suitable values, parameters for generating a signal depending on the kind of the laser diode 11 used, and thus generates the above-mentioned signal. The signal output from the analog-to-digital converter 15 is supplied to a central processing unit (CPU) 21, etc., via a bus 20.

A focus/tracking control circuit 16 generates a focus control signal and a tracking control signal in accordance with the FE signal and the TE signal supplied from the analog-to-digital converter 15, and outputs these signals to the focusing actuator 7 and the tracking actuator 8, thereby driving the objective lens 6. This allows focusing servo whereby the laser light is always focused on the information recording surface of the optical disc 2, and tracking servo whereby the laser light always traces on the track formed on the optical disc 2.

The RF signal is converted into a digital signal by the analog-to-digital converter 15, and supplied to a PLL circuit 17 as a channel bit data. The PLL circuit 17 generates a reproduction clock synchronous with the data and reproduction data on a channel bit unit from the data supplied from the analog-to-digital converter 15, and outputs them to a data reproduction circuit 18. The data reproduction circuit 18 deciphers the format, and demodulates the reproduction data to reproduce byte data, and then outputs the reproduced data to an error correction circuit 19. In the reproduction unit according to the present embodiment, the data reproduction circuit 18 has a reproduction timing detection section 18A.

The reproduction timing detection section 18A has: a pattern detection circuit for detecting the minimum unit of a repetitive pattern contained in the reproduction data; a pattern generation circuit for generating a plurality of phase patterns from the minimum unit pattern detected in the pattern detection circuit; a coincidence determination circuit for determining whether the synchronization code following the VFO field coincides with a plurality of synchronization code patterns stored in, for example, a memory, and predicting head timing of the data following the synchronization code from the coincident synchronization code pattern; a timing coincidence determination section for determining the head timing of the data from the output of the pattern generation circuit and from the output of a synchronization cede pattern coincidence determination circuit; and a demodulation circuit for demodulating the reproduction data using the output of a timing coincidence determination circuit.

Here, the pattern generation circuit generates as many phase patterns as the number of the minimum unit of the repetitive patterns contained in a one-byte unit. Therefore, three phase patterns are generated when the optical disc 2 is the HD DVD type, and four phase patterns are generated when the optical disc 2 is a DVD-RAM.

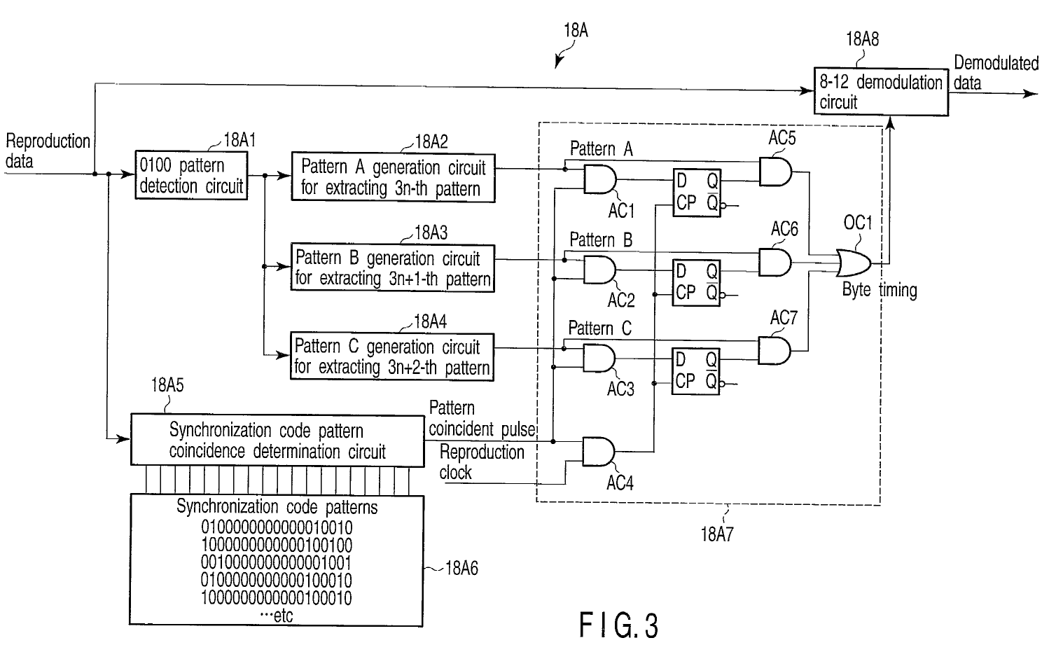

FIG. 3 shows the reproduction timing detection section 18A of the reproduction unit which uses an HD DVD type disc as the optical disc 2. That is, the reproduction timing detection section 18A of the reproduction unit shown in FIG. 3 has a 0100 pattern detection circuit 18A1, a pattern A generation circuit 18A2, a pattern B generation circuit 18A3, a pattern C generation circuit 18A4, a synchronization code pattern coincidence determination circuit 18A5, a timing coincidence determination circuit 18A7, and an 8-12 demodulation circuit 18A8.

The 0100 pattern detection circuit 18A1 detects the “0100” pattern from the VFO field of the reproduction data transmitted from the PLL circuit 17. The pattern A generation circuit 18A2 extracts, for example, 3n-th 0100 pattern from the 0100 pattern signals output from the 0100 pattern detection circuit 18A1 when n is an integral number, and the pattern A generation circuit 18A2 generates a pattern A signal which becomes high with the timing of initial ‘0’ of the 0100 pattern as shown in FIG. 3.

The pattern B generation circuit 18A3 extracts, for example, a 3n+1-th 0100 pattern from the 0100 pattern signals output from the 0100 pattern detection circuit 18A1, and generates a pattern B signal which becomes high with the timing of initial ‘0’ of the 0100 pattern as shown in FIG. 3.

The pattern C generation circuit 18A4 extracts, for example, a 3n+2-th 0100 pattern from the 0100 pattern signals output from the 0100 pattern detection circuit 13A1, and generates a pattern C signal which becomes high with the timing of initial ‘0’ of the 0100 pattern as shown in FIG. 3.

The synchronization code pattern coincidence determination circuit 18A5 refers to a plurality of synchronization code patterns 18A6 stored in, for example, a memory, and determines whether the synchronization code contained in the reproduction data coincides with each of the plurality of synchronization code patterns 18A6.

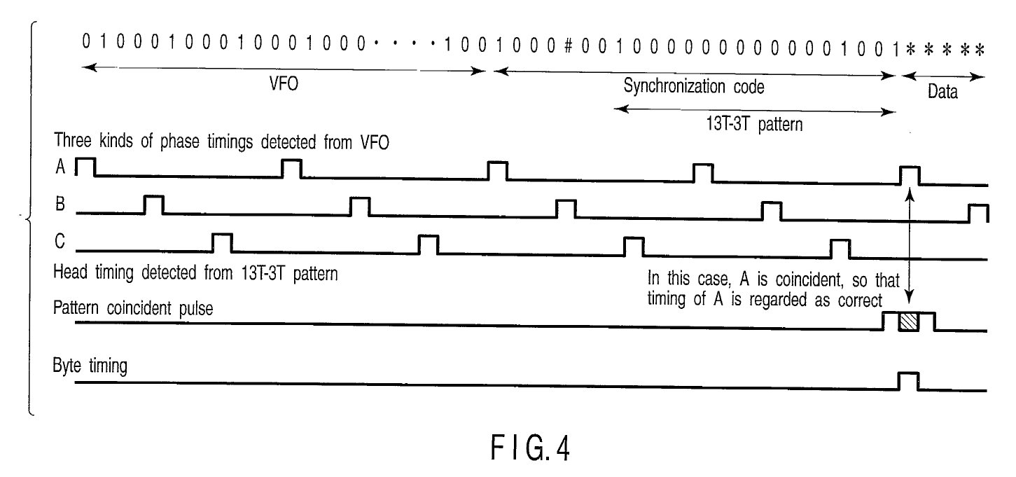

In addition, the synchronization code pattern coincidence determination circuit 18A5 may be configured to determine whether a 13T-3T pattern (e.g., ‘10000000000001001’ shown in FIG. 4) of the synchronization code contained in the reproduction data coincides with each of a plurality of 13T-3T patterns stored in, for example, a memory.

When judging that the plurality of synchronization code patterns 18A6 coincide with the synchronization code contained in the reproduction data, the synchronization code pattern coincidence determination circuit 18A5 predicts the head timing of the data following the synchronization code from the synchronization code pattern, and outputs a pattern coincident pulse which becomes high with the head timing of the data.

When the reproduction data contains a synchronization code as shown in FIG. 4, the synchronization code pattern coincidence determination circuit 18A5 determines that the synchronization code of the reproduction data coincides with ‘100#0010000000000001001’ (# is a value which changes depending on the sector) in the plurality of synchronization code patterns 18A6, and predicts that the timing corresponding to the next channel biz of the synchronization code pattern is the head timing of the data.

Here, as shown in FIG. 4, the synchronization code pattern coincidence determination circuit 18A5 may be configured to predict that timings corresponding to channel bits before and after the next channel bit of the synchronization code of the reproduction data are also head timings, and output a pattern coincident pulse so that the pattern coincident pulse also becomes high with these timings. In the case shown in FIG. 4, the pattern coincident pulse becomes high with the timing corresponding to 3 channel bits headed by the last channel bit of the synchronization code.

The pattern A signal, the pattern B signal, the pattern C signal, the pattern coincident pulse and the reproduction clock are input to the timing coincidence determination circuit 18A7. The timing coincidence determination circuit 18A7 has an OR circuit AC1 to which the pattern A signal and the pattern coincident pulse are input, an OR circuit AC2 to which the pattern B signal and the pattern coincident pulse are input, an OR circuit AC3 to which the pattern C signal and the pattern coincident pulse are input, and an OR circuit AC4 to which the pattern coincident pulse and the reproduction clock are input.

The output of OR circuit AC1 is input to a latch circuit FF1. The output of OR circuit AC2 is input to a latch circuit FF2. The output of OR circuit AC3 is input to a latch circuit FF3. The output of OR circuit AC4 is input to latch circuits FF1, FF2 and FF3.

The timing coincidence determination circuit 18A7 further has an OR circuit AC5 to which the output of latch circuit FF1 and the pattern A signal are input, an OR circuit AC6 to which the output of latch circuit FF2 and the pattern B signal are input, an OR circuit AC7 to which the output of latch circuit FF3 and the pattern C signal are input, and an OR circuit OC1 to which the outputs of OR circuits AC5, AC6 and AC7 are input.

The output of OR circuit OC1 is input to the 8-12 demodulation circuit 18A8 as a byte timing signal. The 8-12 demodulation circuit 18A8 uses the timing with which the byte timing signal becomes high as the head timing of the data, and thus demodulates the data and outputs it to the error correction circuit 19.

The error correction circuit 19 performs an error correction using the error correction code attached to the reproduction data, and then outputs the data to the host device 25 via the interface circuit 24.

The disc motor control circuit 4, the modulation circuit 9, the laser control circuit 10, the analog-to-digital conversion circuit 15, the focus/tracking control circuit 16, the PLL circuit 17, the data reproduction circuit 18, the error correction circuit 19, etc., are controlled by the central processing unit (CPU) 21 via the bus 20.

The CPU 21 comprehensively controls this optical disc recording/reproduction unit 1 in accordance with an operation command supplied from the host device 25 via the interface circuit 24. Further, the CPU 21 uses a random access memory (RAM) 22 as a work area for, for example, a buffer memory during recording/reproduction, and performs predetermined control conforming to a program stored in a read only memory (ROM) 23.

Next, a reproduction method in the above-mentioned reproduction unit will be described with reference to the drawings. The reproduction method according to the present embodiment is a reproduction method of a recording medium in which in a field where a pattern signal repeated by a fixed frequency is recorded, reproduction data is recorded so that an integral multiple of a minimum unit of a pattern thereof is a one-byte unit.

The reproduction method according to the present embodiment comprises: first detecting a minimum unit pattern from a pattern signal; forming an integral number of phase pattern signals from the detected minimum unit pattern; determining a synchronization code following the pattern signal and predicting head timing of data following the synchronization code; determining whether each of the integral number of phase pattern signals formed from the detected minimum unit pattern coincides with the head timing of the predicted data; and demodulating the data using a phase pattern coincident with the head timing of the predicted data as byte timing.

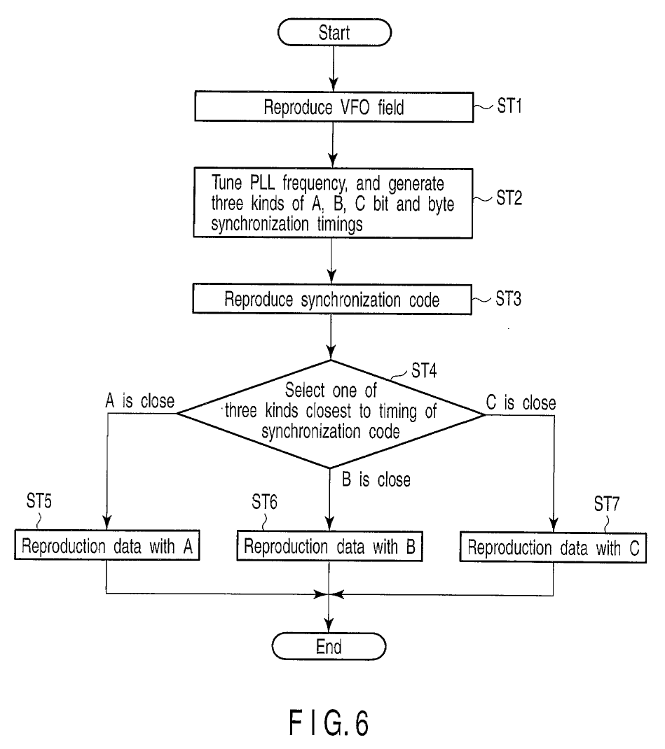

That is, in the case of the reproduction method in the reproduction unit having the reproduction timing detection section 18A as shown in FIG. 2, when reproduction data is input to the data reproduction circuit 18, signals in the VFO field of the reproduction data are reproduced (step ST1), as shown in FIG. 6. That is, the 0100 pattern detection circuit of the data reproduction circuit 18 reproduces the signals in the VFO field to tune a PLL frequency, and also detects a 0100 pattern which is a minimum, unit pattern.

On the basis of the 0100 pattern detected in the 0100 pattern detection circuit 18A1, the pattern A generation circuit 18A2, the pattern B generation circuit 18A3 and the pattern C generation circuit 18A4 generate three kinds of phase patterns, that is, the pattern A signal, the pattern B signal and the pattern C signal as shown in FIG. 4 (step ST2).

Then, the data reproduction circuit 18 reproduces the synchronization code contained in the reproduction data (step ST3). That is, the reproduction data is input to the synchronization code pattern coincidence determination circuit 18A5 of the reproduction timing detection section 18A, and the synchronization code pattern coincidence determination circuit 18A5 determines whether the synchronization code contained in the reproduction data coincides with each of the plurality of synchronization code patterns, and predicts from the coincident synchronization code pattern that the next channel bit of the synchronization code is the head timing of the data, and then outputs a pattern coincident pulse which becomes high with the timing corresponding to this channel bit.

In addition, at this point, it may be predicted that the next channel bit of the synchronization code and channel bits before and after that channel bit are the heads of the data, and a pattern coincident pulse may be output which becomes high with timings corresponding to these channel bits.

Then, one of the timings of the pattern A signal, the pattern 3 signal and the pattern C signal is selected which coincides with the timing predicted to be the head timing of the data by the synchronization code pattern coincidence determination circuit 18A5 (step ST4).

For example, in the case shown in FIG. 4, the timing with which the pattern coincident pulse becomes high is coincident with the timing with which the pattern A signal becomes high. Therefore, the timing coincidence determination circuit 18A7 outputs, as the byte timing, a signal that becomes high with the timing with which the pattern A signal becomes high and with which the pattern coincident pulse becomes high. When the byte timing is input to the 8-12 demodulation circuit 18A8, the 8-12 demodulation circuit 18A8 judges that the byte timing is the head timing of the data contained in the reproduction data, so that the data is demodulated.

That is, as described, above, at the stage of reproducing the VFO field, the minimum unit pattern is detected from the VFO field, and an integral number of phase pattern signals are formed from the detected minimum unit pattern, such that it is possible to provide a reproduction unit and a reproduction method wherein phase synchronization can be easily achieved at the time of the reproduction of the synchronization code.

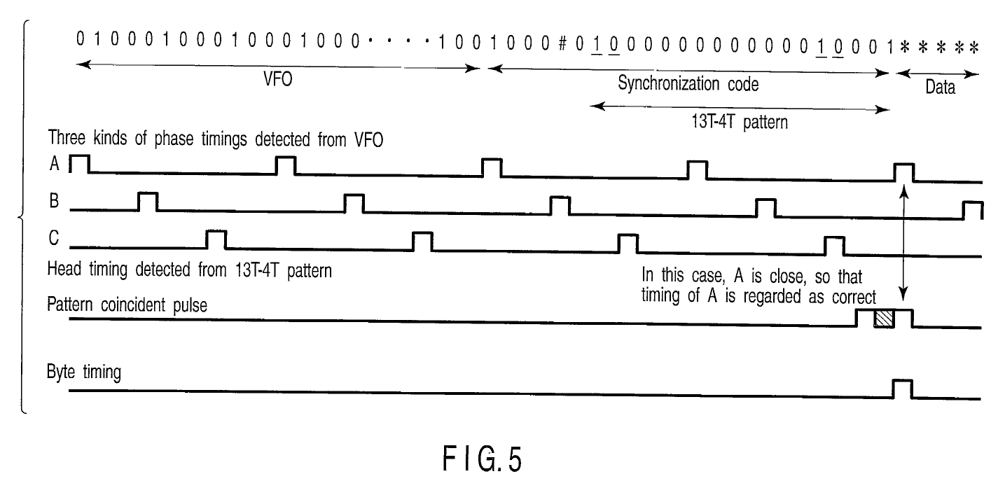

Next, a reproduction method in the case shown in FIG. 5 and FIG. 6 is described. That is, a synchronization code which has been reproduced has an error in the case shown in FIG. 5. In this case, as in the case shown in FIG. 4, when reproduction data is input to the data reproduction circuit 18, signals in the VFO field of the reproduction data are reproduced (step ST1). On the basis of the 0100 pattern detected in the 0100 pattern detection circuit 18A1, the pattern A generation circuit 18A2, the pattern B generation circuit 18A3 and the pattern C generation circuit 18A4 generate three kinds of phase patterns, that is, the pattern A signal, the pattern B signal and the pattern C signal as shown in FIG. 5 (step ST2).

Then, when the data reproduction circuit 18 reproduces the synchronization code contained in the reproduction data (step ST3), the synchronization code pattern coincidence determination circuit 18A5 determines whether the synchronization code contained in the reproduction data coincides with each of the plurality of synchronization code patterns, and predicts from the coincident synchronization code pattern that the next channel bit of the synchronization code and channel bits before and after that channel bit are the heads of the data, and then outputs a pattern coincident pulse which becomes high with the timings corresponding to these channel bits.

Here, as shown in FIG. 5, the synchronization code which has been reproduced has an error, so that the signal has such timing that the 13T-3T patterns of the synchronization code of the reproduction data are shifted one bit earlier. In this case, the head timing of the data predicted in the synchronization code pattern coincidence determination circuit 18A5 is the timing one channel bit earlier than the actual head timing of the data.

Even in such a case, in the reproduction method according to the present embodiment, the pattern coincident pulse output from the synchronization code pattern coincidence determination circuit 18A5 also becomes high with the timings corresponding to the channel bits before and after the head of the data predicted from the synchronization code pattern, as shown in FIG. 5.

Therefore, even when the synchronization code reproduced as shown in FIG. 5 has an error, one of the timings of the pattern A signal, the pattern B signal and the pattern C signal is selected which coincides with the timing predicted to be the head of the data by the synchronization code pattern coincidence determination circuit 18A5 (step ST4), such that the head timing of the data can be correctly selected.

For example, in the case shown in FIG. 5, the timing with which the pattern coincident pulse becomes high is coincident with the timing with which the pattern A signal becomes high. Therefore, the timing coincidence determination circuit 18A7 outputs, as the byte timing, a signal that becomes high with the timing with which the pattern A signal becomes high and with which the pattern coincidence pulse becomes high. When the byte timing is input to the 8-12 demodulation circuit 18A8, the 8-12 demodulation circuit 18A8 judges that the byte timing is the head timing of the data contained in the reproduction data, so that the data is demodulated.

That is, the reproduction in the above-mentioned manner makes it possible to select the timing with which the pattern A signal becomes high as the head timing of the data, and reproduce the data with correct timing as in the case shown in FIG. 4, even when the synchronization code that has been reproduced has an error as in the case shown in FIG. 5.

As described above, according to the reproduction unit and the reproduction method in the present embodiment, at the stage of reproducing the pattern signal, the minimum unit pattern is detected from the pattern signal, and an integral number of phase pattern signals are formed from the detected minimum unit pattern, such that it is possible to provide a reproduction unit and a reproduction method wherein phase synchronization can be easily achieved at the time of the reproduction of the synchronization code. Moreover, it is possible to provide a reproduction unit and a reproduction method capable of reproducing data even when the synchronization code is not detected correctly.

In addition, when the synchronization code is located next to the VFO field, the bit and the byte are synchronized by the method according to the present invention, but the bit and the byte are synchronized by the synchronization code as heretofore in a field where the synchronization code is within the data. Moreover, when the VFO field is defective and the patterns A, B, C are not generated correctly, the bit and the byte are synchronized by the synchronization code as heretofore.

It is to be noted that this invention is not completely limited to the embodiment described above, and the components can be modified and embodied at the stage of carrying out the invention without departing from the spirit thereof. For example, although the HD DVD type disc is used as the optical disc 2 in the case described above as an example in the embodiment, the present invention is applicable to any reproduction unit and its reproduction method for reproducing a recording medium in which data is recorded so that an integral multiple of a minimum unit of a repeated, pattern is a one-byte unit in a pattern field where the pattern is repeated by a fixed frequency, even when other recording media such as optical discs are used.

Furthermore, in the reproduction unit and the reproduction method according to the embodiment described above, it is predicted that net only the timing corresponding to the next channel bit of the synchronization code but also timings corresponding to one channel bit before and one channel bit after that channel bit are the head timings, such that a signal which becomes high with these timings is defined as the pattern coincident pulse.

However, the timing defined as the predicted timing has only to contain timing corresponding to at least the next channel bit of the synchronization code, and whether to treat the timings corresponding to the channel bits before and after that channel bit as the head timings may be suitably changed depending on the length (the number of bits) of the minimum unit pattern detected from the VFO field and on the sequence of the synchronization codes.

For example, it may be predicted that the head timings are the timing corresponding to the next channel bit of the synchronization code and the timing corresponding to one channel bit before that channel bit or that the head timings are the timing corresponding to the next channel bit of the synchronization code and the timing corresponding to one channel bit after that channel bit. Further, depending on the length of the minimum unit pattern, it nay be predicted that the head timings are the timing corresponding to the next channel bit of the synchronization code and the timings corresponding to two or more channel bits before and after that channel bit.

Furthermore, various inventions can be formed by suitable combinations of a plurality of components disclosed in the embodiment described above. For example, some of all the components shown in the embedment may be eliminated. Moreover, the components in different embodiments may be suitably combined together.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from, the spirit of the inventions. The accompanying claims and their equivalents are intended to cover such forms or modifications as would fall within the scope and spirit of the inventions.

What is claimed is:

1. A reproduction unit of a recording medium in which in a field where a pattern signal repeated by a fixed frequency is recorded, reproduction data is recorded so that an integral multiple of a minimum unit of a pattern thereof is a one-byte unit, the reproduction unit comprising:
detection means for detecting a minimum unit pattern from the pattern signal;
pattern forming means for forming an integral number of phase pattern signals from the minimum unit pattern detected by the detection means;
synchronization code determination means for determining a synchronization code following the pattern signal and predicting head timing of data following the synchronization code; and
timing coincidence determination means for determining whether each of the integral number of phase pattern signals coincides with the head timing of the data predicted by the synchronization code determination means.

2. The reproduction unit of claim 1, wherein the synchronization code determination means has correction means for predicting that at least one of timings before and after the head timing of the data predicted from the result of the determination of the synchronization code is also the head timing of the data.

3. The reproduction unit of claim 1 or 2, wherein the reproduction data recorded in the recording medium is data modulated by an 8-12 modulation method.

4. A reproduction method of a recording medium in which in a field where a pattern signal repeated by a fixed frequency is recorded, reproduction data is recorded so that an integral multiple of a minimum unit of a pattern thereof is a one-byte unit, the reproduction method comprising:
a detection step of detecting a minimum unit pattern from the pattern signal;
a phase pattern forming step of forming an integral number of phase pattern signals from, the minimum unit pattern detected by the detection means;
a synchronization code determination step of determining a synchronization code following the pattern signal and predicting head timing of data following the synchronization code; and
a timing coincidence determination step of determining whether each of the integral number of phase pattern signals coincides with the head timing of the data predicted in the synchronization code determination step.

5. The reproduction method of claim 4, wherein the synchronization code determination step further has a correction step of predicting that at least one of timings before and after the head timing of the data predicted from the result of the determination of the synchronization code is also the head timing of the data.
